(19) United States
(12) Patent Application Publication
(10) Pub. No.: US 2023/0287206 A1
(43) Pub. Date: Sep. 14, 2023

(54) RESIN COMPOSITION, RESIN MOLDED ARTICLE, AND METHOD FOR PRODUCING RESIN MOLDED ARTICLE

(71) Applicant: CANON KABUSHIKI KAISHA, Tokyo (JP)

(72) Inventors: TAKAHIRO KOJIMA, Kanagawa (JP); AKIRA YANE, Tokyo (JP); MIDORI OGATA, Tokyo (JP); TAKAO SAKAKIBARA, Tokyo (JP)

(21) Appl. No.: 18/177,048

(22) Filed: Mar. 1, 2023

(30) Foreign Application Priority Data
Mar. 7, 2022 (JP) 2022-034504

(51) Int. Cl. C08L 29/14; C08L 23/06; C08K 3/04; C08K 5/353; C08K 5/5397; C08K 5/5377; C08K 5/101

(52) U.S. Cl. CPC C08L 29/14; C08K 3/04; C08K 5/101; C08K 5/353; C08K 5/5377; C08K 5/5397; C08L 23/06; C08K 2201/001; C08K 2201/014; C08L 2201/08; C08L 2203/20; C08L 2203/30; C08L 2205/22

(57) ABSTRACT

For the purpose of providing a POM resin composition containing a conductive filler, the conductive POM resin composition suppressing the amount of the curing accelerator to be added, having excellent low thermal decomposition mechanical physical properties, and having no practical problem for injection molding applications, and a resin molded article, provided is a resin composition including a polyacetal resin, polyethylene, carbon black, a reaction product of an oxazoline group-containing polymer represented by formula (1), and a tertiary aromatic phosphine represented by formula (3) and/or a tertiary aromatic phosphine oxide represented by formula (4), wherein a content of the polyacetal resin is 50% by mass or more, and a sum of the content of the tertiary aromatic phosphine and the content of the tertiary aromatic phosphine oxide is 0.2% by mass or more and less than 0.5% by mass.

### BACKGROUND OF THE INVENTION

### Field of the Invention

The present disclosure relates to a conductive resin composition containing a polyacetal resin as a main component, a resin molded article including the resin composition, and a method for producing the resin molded article.

### Description of the Related Art

A polyacetal resin (POM resin) is a resin having balanced mechanical properties and excellent slidability. The resin is excellent particularly in slidability, and hence has been widely used in, for example, various precision mechanism parts including a gear and OA equipment. Meanwhile, in recent years, the integration of members has been required in various applications, and thus POM resins having conductivity in addition to slidability are desired. Accordingly, POM resins including a conductive filler added thereto have been applied to members having a function of removing static electricity that occurs during sliding or a function as conductive wiring.

In a POM resin composition including a conductive filler added thereto, heat generation is likely to occur in a plasticizing process because of increase in the melt viscosity due to addition of the filler. Alternatively, when an organic functional group having active hydrogen, particularly an acidic proton, which facilitates a decomposition reaction of the POM resin, is present on the surface or the like of the filler, formaldehyde, a thermal decomposition product, is liable to be generated.

Japanese Patent Application Laid-Open No. 2009-269996 discloses a POM resin composition having thermal stability and high conductivity imparted, the POM resin composition having been obtained by adding conductive carbon black or graphite followed by blending of an olefinic resin, an ester including a fatty acid and an aliphatic alcohol, and an epoxy compound. In the POM resin composition, conceivably, the ester including a fatty acid and an aliphatic alcohol serves as a lubricant to suppress heat generation in a process of kneading, plasticizing molding, or the like, and the epoxy compound reacts with an organic functional group having active hydrogen to suppress a decomposition reaction.

### SUMMARY OF THE INVENTION

Epoxy compounds react with various organic functional groups, but the reaction conditions vary according to the compounds. Epoxy compounds are broadly divided into a type of epoxy compounds that are cured at a low temperature to room temperature and a type of epoxy compounds that are cured at a higher temperature. For those cured at a low temperature to room temperature, for example, an aliphatic polyamine or polymercaptan is used as a curing agent. For those cured at a higher temperature, for example, an aromatic polyamine, acid anhydride, phenol novolac resin, or dicyandiamide is used as a curing agent. Those cured at a higher temperature are also effective in applications of addition to a thermoplastic resin because of the heat resistance and high mechanical strength.

In contrast, when an acid anhydride, phenol novolac resin, or dicyandiamide is used as the curing agent, because of its poor reaction rate, an accelerator to accelerate a curing reaction is desirably used in combination. As the reaction accelerator, a tertiary amine or salt thereof, imidazole salt, sulfonium salt, phosphine, or phosphonium salt is used. Many of these accelerators are compounds having a low melting point or organic salts. Excessive addition thereof is accompanied by bleed-out from the material or decrease in mechanical properties (impact resistance, temperature of deflection under load, and the like) due to the addition. Thus, if the accelerator is used, attention must be paid on the amount thereof to be added.

In the POM resin composition disclosed in Japanese Patent Application Laid-Open No. 2009-269996, 0.5 parts by mass to 1.0 part by mass of triphenylphosphine is added as an epoxy resin curing agent.

It is an aspect of the present disclosure to provide a conductive POM resin composition, the resin composition including a non-epoxy curing accelerator to suppress the amount of the curing accelerator to be added, being less likely to be thermally decomposed, having excellent mechanical properties, and having no practical problem for injection molding applications, and a resin molded article, and a method for producing the same.

An embodiment of the present disclosure provides a resin composition including a polyacetal resin, polyethylene, a reaction product of an oxazoline group-containing polymer represented by the following formula (1) with carbon black, and a tertiary aromatic phosphine represented by the following formula (3) and/or a tertiary aromatic phosphine oxide represented by the following formula (4), wherein the content of the polyacetal resin is 50% by mass or more, and the sum of the content of the tertiary aromatic phosphine and the content of the tertiary aromatic phosphine oxide is 0.2% by mass or more and less than 0.5% by mass.

Further, an embodiment of the present disclosure provides a method for producing a resin molded article, comprising kneading and heating a raw material, followed by molding, the raw material including a polyacetal resin, polyethylene, carbon black, an oxazoline group-containing polymer represented by the following formula (2), and a tertiary aromatic phosphine represented by the following formula (3) and/or a tertiary aromatic phosphine oxide represented by the following formula (4).

In the raw material, the content of the polyacetal resin is 50% by mass or more, and the sum of the content of the tertiary aromatic phosphine and the content of the tertiary aromatic phosphine oxide is 0.2% by mass or more and less than 0.5% by mass.

Further features of the present disclosure will become apparent from the following description of exemplary embodiments with reference to the attached drawings.

### BRIEF DESCRIPTION OF THE DRAWINGS

FIG. 1 is a conceptual diagram illustrating a model of a resin composition of the present embodiment.

FIG. 2 is an electron micrograph illustrating the raw material of the resin composition of the present embodiment mixed with a twin screw extruder.

FIG. 3 is a graph in which the Charpy impact resistance values and the temperatures of deflection under load of resin compositions produced in Examples 1 to 4 and Comparative Examples 1 to 2 are plotted.

### DESCRIPTION OF THE EMBODIMENTS

Preferred embodiments of the present disclosure will now be described in detail in accordance with the accompanying drawings.

The present disclosure provides, as a first embodiment, a resin composition including a polyacetal resin, polyethylene, carbon black, a reaction product of an oxazoline group-containing polymer represented by formula (1), and a tertiary aromatic phosphine represented by formula (3) and/or a tertiary aromatic phosphine oxide represented by formula (4), wherein the content of the polyacetal resin is 50% by mass or more, and the sum of the content of the tertiary aromatic phosphine and the content of the tertiary aromatic phosphine oxide is 0.2% by mass or more and less than 0.5% by mass.

The formula (1) is represented as follows.

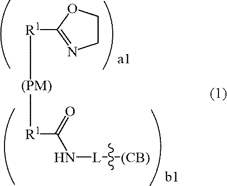

In the formula (1), PM represents a polymer including at least any of a styrene unit, an acryl unit, or an acrylonitrile unit,

L represents a divalent linking group having 10 or less carbon atoms and including at least one group selected from the group consisting of an alkylene group, —CO—, —O—, —NH—, and —S—, and the alkylene group optionally has a substituent,

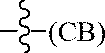

represents a bond to the carbon black (carbon black represented by CB on the right of the wavy line is not included in the formula (1)), each R¹ independently represents a single bond or a divalent hydrocarbon group having 5 or less carbon atoms optionally having a substituent, a1 is an integer of 0 or 1 or more, and b1 is an integer of 1 or more.

The formula (3) is represented as follows.

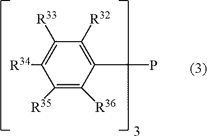

In the formula (3), R³² to R³⁶ each independently represent a hydrogen atom or an alkyl group having 2 or less carbon atoms.

The formula (4) is represented as follows.

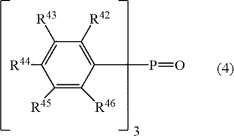

In the formula (4), R⁴² to R⁴⁶ each independently represent a hydrogen atom or an alkyl group having 2 or less carbon atoms.

The present disclosure also provides, as a second embodiment, a resin molded article including the resin composition.

The present disclosure further provides, as a third embodiment, a method for producing a resin composition, comprising kneading and heating a raw material including a polyacetal resin, polyethylene, carbon black, an oxazoline group-containing polymer represented by formula (2), and a tertiary aromatic phosphine represented by formula (3) and/or a tertiary aromatic phosphine oxide represented by formula (4), and also a method for producing a resin molded article, including molding the resin composition. In the raw material, the content of the polyacetal resin is 50% by mass or more, and the sum of the content of the tertiary aromatic phosphine and the content of the tertiary aromatic phosphine oxide is 0.2% by mass or more and less than 0.5% by mass.

The formulas (3) and (4) are as described above.

The formula (2) is represented as follows.

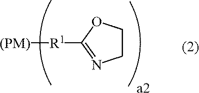

In the formula (2), PM represents a polymer including at least any of a styrene unit, an acryl unit, or an acrylonitrile unit, R¹ represents a single bond or a divalent hydrocarbon group having 5 or less carbon atoms optionally having a substituent, and a2 is an integer of 1 or more.

a2 in the formula (2) corresponds to the number of oxazoline groups included in the oxazoline group-containing polymer. Meanwhile, b1 in the formula (1) corresponds to the number of oxazoline groups that has reacted with and bonded to the carbon black among the oxazoline groups of the oxazoline group-containing polymer, and a1 corresponds to the number of unreacted oxazoline groups of the oxazoline group-containing polymer. a2, a1, and b1 each are not limited, a2 is preferably from 0.1 mmol (i.e., 6.02 × 10¹⁹) to 10 mmol (i.e., 6.02 × 10²¹) based on 1 g of the polymer, the sum of a1 and b1 is preferably from 0.1 mmol (i.e., 6.02 × 10¹⁹) to 10 mmol (i.e., 6.02 × 10²¹) based on 1 g of the polymer, and the ratio of a1 to b1 is preferably from 0:10 to 10:1. a2 is 100 or more and 200,000 or less and more preferably 1,000 or more and 20,000 or less, the sum of a1 and b1 is preferably 100 or more and 200,000 or less and more preferably 1,000 or more and 20,000 or less, and the ratio of a1 to b1 is preferably from 0:10 to 10:1.

That is, in the formula (1), a1 and b1 preferably satisfy 100 ≤ a1 + b1 ≤ 200,000 and 0.1 ≤ b1/a1, and in the formula (2), a2 preferably satisfies 100 ≤ a2 ≤ 200,000.

### Construction of Resin Composition

The resin composition has high conductivity and mechanical strength under the construction conditions described above.

An oxazoline compound is a 5-membered heterocyclic compound having a chemical formula C₃H₅NO, and an oxazoline group refers to a 5-membered heterocyclic group having C₃H₄NO represented in the formula (5). The oxazoline compound is known to react with an organic functional group of such as a carboxylic acid compound or a compound to give an amide ester compound, which is a fused compound of N-acyl ethanolamine, formed by ring-opening of the oxazoline group, and an organic functional group.

An exemplary reaction of the oxazoline group and a phenol is shown in the formula (5).

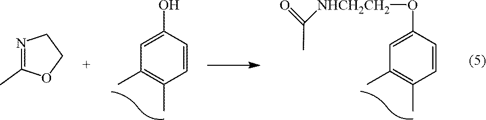

When the oxazoline group of the oxazoline group-containing polymer is applied to the formula (5), -L- in the formula (1) is —CH₂CH₂—O—. L may be any divalent group having 10 or less carbon atoms and including a group selected from the group consisting of an alkylene group, —CO—, —O—, —NH—, and —S—, in addition to —CH₂CH₂—O—. When the oxazoline group reacts with a carboxyl group on the carbon black surface, -L-is —CH₂CH₂—O—CO—. When the oxazoline group reacts with a thiol group (—SH) on the carbon black surface, -L- is —CH₂CH₂—S—.

On the surface of the carbon black, organic functional groups such as a carboxyl group (—COOH) or a hydroxyl group (—OH) derived from the production process remain. These organic functional groups, which have acidic active hydrogen (protons), facilitate a decomposition reaction of the POM resin, being liable to generate formaldehyde, a thermal decomposition product. The oxazoline compound reacts with an organic functional group having a proton to generate a fused compound. Thus, incorporation of an oxazoline group-containing polymer compound in the resin composition causes organic functional groups on the carbon black surface to be consumed. As a result, the decomposition reaction of the POM resin facilitated by the organic functional groups can be suppressed.

The oxazoline compound reacts with a carboxylic acid or a thiol in the absence of a catalyst, but, in the case of a reaction with a phenol, an aromatic phosphorus compound may be effectively used as a reaction accelerator. The resin composition of the present embodiment includes a tertiary aromatic phosphine in order to accelerate a reaction between the oxazoline group and the organic functional group. Examples of the aromatic phosphorus compound include tertiary aromatic phosphines, triphenyl phosphites, tertiary aromatic phosphates, and ones obtained by replacing hydrogen on the aromatic ring of these compounds with an organic functional group. However, phosphites and phosphates, which are acidic phosphorus compounds, induce the decomposition reaction of the POM resin, and thus a tertiary aromatic phosphine (formula (3)) such as triphenylphosphine is suitable for the resin composition of the present embodiment.

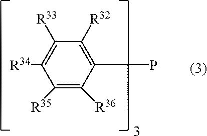

In the formula (3), R³² to R³⁶ each independently represent a hydrogen atom or an alkyl group having 2 or less carbon atoms.

The tertiary aromatic phosphine reacts with oxygen or an oxidizing agent included in the system and is oxidized to be a tertiary aromatic phosphine oxide (formula (4)) such as triphenylphosphine oxide.

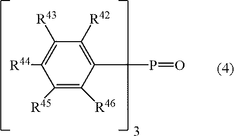

In the formula (4), R⁴² to R⁴⁶ each independently represent a hydrogen atom or an alkyl having 2 or less carbon atoms.

The tertiary aromatic phosphine is used as a reaction accelerator for an epoxy compound and a curing agent. The epoxy compound, which has a 3-membered ring structure and has oxygen, serves as an oxidizing agent to be converted into an olefin. Thus, the catalytic reaction of the epoxy compound competes with the oxidation reaction of triphenylphosphine. Accordingly, an amount thereof more than needed for the catalytic reaction is required to be added, and this addition is likely to affect the mechanical physical properties (impact resistance, temperature of deflection under load, and the like). In contrast, the oxazoline compound is unlikely to allow the oxidation reaction to proceed. Then, a less content of the tertiary aromatic phosphine and the tertiary aromatic phosphine oxide, which is an oxide thereof, is required, and the mechanical physical properties are unlikely to decrease.

When a reaction is generally conducted in a viscous fluid of a high viscosity such as a melt resin, not in a solution system, particularly when the reaction is caused under passage through a continuous reactor such as a kneading extruder, the reaction rate and time are limited. Thus, the reaction accelerator during material mixing is desirably added in an amount more than the catalyst equivalent. The tertiary aromatic phosphine is oxidized by air to be a tertiary aromatic phosphine oxide, losing the catalytic activity. For this reason, in the resin composition of the present embodiment, the sum of the contents of the tertiary aromatic phosphine and the tertiary aromatic phosphine oxide is 0.2% by mass or more and less than 0.5% by mass. This sum is approximately equal to the proportion of the amount of the tertiary aromatic phosphine added based on the total amount of the materials for use in charging of the materials.

When the resin composition of the present embodiment has a sum of the contents of the tertiary aromatic phosphine and the tertiary aromatic phosphine oxide less than 0.2% by mass, the reaction between the oxazoline group-containing polymer compound and the organic functional group on the carbon black surface becomes insufficient, decomposition of the POM resin proceeds, and decrease in the mechanical physical properties due to lowering of the molecular weight may be proceed. In contrast, presence of an excessive amount of these compounds is accompanied by decrease in the mechanical physical properties, and thus the resin composition of the present embodiment has a sum of the contents of the tertiary aromatic phosphine and the tertiary aromatic phosphine oxide of less than 0.5% by mass and more preferably less than 0.45% by mass.

For the temperature of deflection under load among the mechanical physical properties, the content of a low-melting-temperature additive is important, and the content of the tertiary aromatic phosphine, which has a melting temperature lower than that of the tertiary aromatic phosphine oxide, in the resin composition is preferably less than 0.3% by mass.

For the impact resistance among the mechanical physical properties, the content of a low-molecular weight component is important, and the content of the tertiary aromatic phosphine oxide in the resin composition, of which the abundance ratio in the resin composition is likely to be actually larger, due to air oxidation, than that of the tertiary aromatic phosphine, is preferably less than 0.4% by mass.

The fact that the mechanical physical properties are greatly dominated by controlling the amount added of the tertiary aromatic phosphine and the tertiary aromatic phosphine oxide in a catalytic amount, which can be said to be an extremely trace amount with respect to the polyacetal resin and the resin composition, is a surprising finding found by the present inventors. The reason for this, although not clear, is conceived to be ascribed to the dispersion structure of the resin alloy and carbon black in the resin composition of the present embodiment.

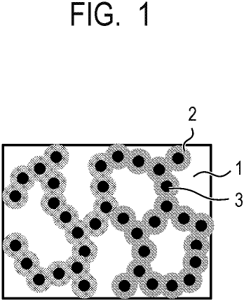

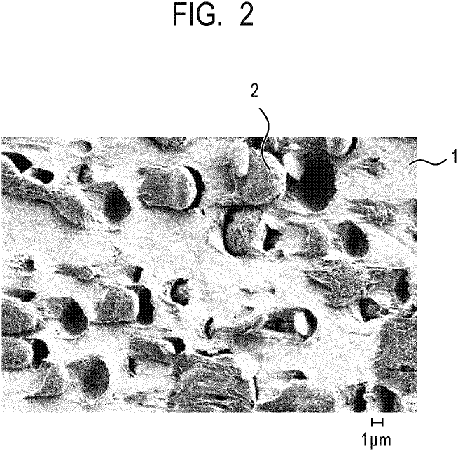

FIG. 1 illustrates a conceptual diagram of the resin composition of the present embodiment, and FIG. 2 is an image obtained by observing the raw material of the resin composition of the present embodiment mixed in a twin screw extruder, with an electron microscope. In order to obtain a clear image with an electron microscope, the concentration of the carbon black in the resin composition is set to 1% by mass.

As shown in FIG. 1 and FIG. 2, the polymer blend of the POM resin and the polyethylene has an incompatible sea-island structure or a co-continuous structure in which islands are beaded. That is, in FIG. 1, an island phase 2 including polyethylene is present in a sea phase 1 including the POM resin. Carbon black 3 is present locally on the polyethylene side. The oxazoline group-containing polymer compound, tertiary aromatic phosphine, and tertiary aromatic phosphine oxide, which react with the organic functional group of the carbon black, are presumed to be present in the phase on the polyethylene side.

The above structure contributes to the slidability and conductivity of the resin composition, and thus the content of the polyethylene is preferably 5% by mass or more and 15% by mass or less in the resin composition of the present embodiment. The content of the carbon black is preferably 7% by mass or more and 13% by mass or less.

When the content of the polyethylene falls below 5% by mass, or the content of the carbon black exceeds 13% by mass, formation of the above structure is prevented, and the slidability may deteriorate. Alternatively, when the content of the carbon black falls below 7% by mass, or the content of the polyethylene exceeds 15% by mass, the carbon black relative concentration in the phase on the polyethylene side decreases, and thus the conductivity may deteriorate.

Meanwhile, in view of the mechanical physical properties, the phase on the polyethylene side in which the carbon black is localized has to be noted. When the content of the tertiary aromatic phosphine or the tertiary aromatic phosphine oxide is excessively high, the phase on the polyethylene side becomes plastic or brittle. Then, delamination at the interface between the carbon black and the resin is conceived to be more likely to occur, leading to decrease in the mechanical physical properties.

As the proportion of the polyethylene in the resin composition is preferably in the range of 5% by mass or more and 15% by mass less as mentioned above, control of the trace content of the tertiary aromatic phosphine or the tertiary aromatic phosphine oxide is conceived to effectively act on the characteristics of the phase on the polyethylene side to greatly dominate the mechanical physical properties.

The oxazoline group-containing polymer compound used in the present embodiment has an aromatic ring in its molecular structure. When the oxazoline group-containing polymer compound has an aromatic ring, the oxazoline group-containing polymer compound is expected to be adsorbed on the carbon black due to the electronic interaction of the carbon black having a conductive carbon atom of an sp2 hybridized orbital. As a result, the organic functional group having a proton on the carbon black surface preferentially reacts with the oxazoline group to enable the decomposition reaction of the POM resin to be suppressed more effectively.

In the reaction product of the oxazoline group-containing polymer represented by the formula (1) used in the present embodiment or in the oxazoline group-containing polymer compound represented by formula (2), the polymer including at least any of a styrene unit, an acryl unit, or an acrylonitrile unit represented by PM more specifically may be styrene, acryl, styrene/acryl copolymer (SA), styrene/acrylonitrile copolymer (SAN), or the like. Of these, for example, one including a styrene unit represented by the formula (6) is desirable.

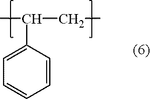

Commercially available oxazoline group-containing polymer compounds also can be used. Although the molecular weight of the polymer is not particularly limited, the weight average molecular weight is preferably 10,000 or more and 200,000 or less.

Specific examples can include “EPOCROS® RPS-1005S (model number)” manufactured by NIPPON SHOKUBAI CO., LTD., which is oxazoline-modified polystyrene including the structure represented by the following formula (7) as the main component.

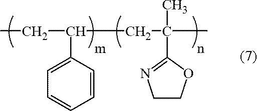

In the above formula (7), m and n each represent an integer of 1 or more. The polymer compound of the formula (7) is one of the specific examples of the formula (2). In this case, PM is a polymer including a styrene unit, and R¹ is a single bond. R¹ is, in addition to a single bond, a divalent hydrocarbon group having 5 or less carbon atoms optionally having a substituent, and may be a group formed by combination of an alkylene group, an oxy group, a carbonyl group, or an amino group, for example.

Additionally, the stoichiometric amount of the sum of the oxazoline group-containing polymer compound and the reaction product thereof in the resin composition (converted in terms of an oxazoline group unit) is preferably 0.02 mmol or more and 2 mmol or less based on 1 g of the carbon black in the resin composition of the present embodiment. This stoichiometric amount is more preferably 0.02 mmol or more and 0.2 mmol or less. When this amount is less than 0.02 mmol, the amount of the oxazoline group is not sufficient for the organic functional groups present in the carbon black surface, some of the organic functional groups remain, and the effect of suppressing the decomposition reaction of the POM resin will be weakened. Alternatively, when the stoichiometric amount exceeds 2 mmol, unreacted oxazoline groups are likely to remain in the resin composition, and the long-term stability of the resin composition and the resin molded article is likely to be impaired.

The constituent components of the resin composition of the present embodiment are now described.

### POM Resin

The resin composition of the present embodiment is a resin composition including the POM resin as the main component. The main component here means that the proportion of the POM resin in the resin composition is 50% by mass or more. From the viewpoint of securing the slidability and strength intrinsic in polyacetal, the proportion of the POM resin is more preferably 70% by mass or more.

Examples of the POM resin used in the present embodiment typically include a polyacetal homopolymer substantially formed only of an oxymethylene unit, which is obtained by homopolymerizing a formaldehyde monomer or a multimer thereof (e.g., trioxane), and a polyacetal copolymer, which is obtained by copolymerizing a formaldehyde monomer or a multimer thereof (e.g., trioxane) and a glycol, a cyclic ether, or a cyclic formal, such as ethylene oxide, propylene oxide, epichlorohydrin, or 1,3-dioxolane.

The polyacetal copolymer may be preferably used in terms of chemical stability. In addition, a polyacetal copolymer having a crosslinked structure or a block structure may be used according to the type of the copolymer, and the structural feature of the polyacetal copolymer is not particularly limited.

Although the terminal structure of the polymer is also not particularly limited, when a hydroxy group of the oxymethylene unit or an aldehyde is present in a terminal portion thereof, the terminal portion serves as the starting point of the thermal decomposition of the polymer, and it is difficult to practically use the polymer as is. A POM resin is preferably used which is obtained by subjecting a terminal of the oxymethylene unit to a chemical sealing treatment, or subjecting the unstable terminal portion to a decomposition treatment with amine, an ammonium compound, or the like, to cause a copolymer component except the oxymethylene unit to serve as a terminal.

As the POM resin used in the present embodiment, a commercially available POM resin including various additives added thereto according to its applications may be used. Specific examples can include the following:

DURACON® series manufactured by Polyplastics Co., Ltd., TENAC® series and TENAC®-C series manufactured by Asahi Kasei Corporation, and Iupital (trademark) series manufactured by Mitsubishi Engineering-Plastics Corporation.

Alternatively, two or more of these POM resins may be used in mixture.

The melt flow rate (MFR, measured under conditions of JIS-K7210) of the POM resin used in the present embodiment is from 0.5 g/10 min to 100 g/10 min and preferably from 1 g/10 min to 50 g/10 min at 190° C.

### Polyethylene

Polyethylene is included in the resin composition of the present embodiment. As the polyethylene, low-molecular weight polyethylene is preferably used. Examples of the commercially available low-molecular weight polyethylene can include the following:

“UBE Polyethylene (product name)” manufactured by Ube Polyethylene, “Suntec (TM)” series manufactured by Asahi Kasei Corporation, “SUMIKATHENE®” series, manufactured by Sumitomo Chemical Company, Limited, “FLO-THENE (product name)” manufactured by Sumitomo Seika Chemicals Company, Limited, “Petrothene®” series manufactured by TOSOH CORPORATION, “NOVATEC LD (TM)” series manufactured by Japan Polyethylene Corporation, and “NEO-ZEX®” series, “ULTZEX ®” series, and “Evolue®” series manufactured by Prime Polymer Co., Ltd.

Alternatively, two or more of these polyethylenes may be used in mixture.

The polyethylene having a tensile yield stress of 10 MPa or more is more preferable. The content of the polyethylene in the resin composition of the present embodiment is preferably 5% by mass or more and 15% by mass or less. When the content of the polyethylene is set to 5% by mass or more, a resin composition having high impact resistance in addition to abrasion resistance can be obtained, and when the content of the polyethylene is set to 15% by mass or less, a resin composition excellent in conductivity can be obtained.

### Carbon Black

The carbon black used in the present embodiment is carbon black that is conductive and has a developed chain structure. Carbon black having an average primary particle diameter as an aggregate (aggregate diameter) in the range of 0.05 µm or more to 1 µm or less is preferably used. The amount of the carbon black added is preferably 5% by mass or more and 25% by mass or less in the resin composition of the present embodiment. An amount of the carbon black added of 5% by mass or more is preferable because satisfactory conductivity can be obtained, and an amount of the carbon black added of 25% by mass or less is preferable because heat generation during molding is small and thermal decomposition of the POM resin is unlikely to occur. An amount of the carbon black added of 15% by mass or less is more preferable because the flowability of the resin composition during molding is satisfactory. In order to achieve both the thermal decomposition and the conductivity of the POM resin in a well-balanced manner, the amount added is particularly preferably 7% by mass or more and 13% by mass or less.

In addition, in order to obtain a resin composition having sufficient conductivity within the above range of the amount added, the carbon black preferably has a dibutyl phthalate oil absorption (DBP oil absorption, ASTM D2415-65T) of 250 ml/100 g or more.

Specific examples of the carbon black used in the present embodiment can include the following:
“DENKABLACK®” (DBP oil absorption of particulate product: 160 ml/100 g) manufactured by Denka Company Limited,
“SEAST (product name)” series (DBP oil absorption: 40 to 160 ml/100 g) and “TOKABLACK (product name)” series (DBP oil absorption: 50 to 170 ml/100 g) manufactured by Tokai Carbon Co., Ltd., and
“Mitsubishi Carbon Black (product name)” series (DBP oil absorption: 40 to 180 ml/100 g) manufactured by Mitsubishi Chemical Corporation.

Those having a DBP oil absorption more than 250 ml/100 g are as follows:
“Ketjen black (product name)” series (DBP oil absorption: 350 to 500 ml/100 g) and “LIONITE (product name)” series (DBP oil absorption: 250 to 400 ml/100 g), manufactured by Lion Specialty Chemicals Co., Ltd.; and
“PRINTEX (product name)” series (50 to 420 ml/100 g) manufactured by Orion Engineered Carbons.

Two or more carbon blacks may be used in combination.

### Graphite

The resin composition can contain graphite. The graphite used in the present embodiment may be appropriately selected from an artificial product and a natural product according to purposes. The shape of the graphite is not particularly limited, and any one of, for example, a flaky shape, a lump shape, a spherical shape, and an earthy shape is permitted, but flaky graphite is preferred from the viewpoint of the expression of more satisfactory conductivity.

The average particle diameter of the graphite used in the present embodiment is preferably in the range of 0.5 µm to 100 µm and more preferably in the range of 20 µm to 80 µm. The average particle diameter is preferably 20 µm or more from the viewpoints of high conductivity and dimensional stability when the temperature changes, and is preferably 100 µm or less from the viewpoints of handleability and the surface property of a molded article.

Specific examples of the flaky graphite can include “CP (product name)” series and “F# (product name)” series manufactured by Nippon Graphite Industries, Co., Ltd. and “CNP (product name)” series and “Z (product name)” series manufactured by Ito Graphite Co., Ltd. Two or more graphites may be used in combination. The amount of the graphite added is preferably in the range of 2% by mass or more and 8% by mass or less in the resin composition.

### Other Additives

Other various additives may be blended as required in the resin composition of the present embodiment. Examples of various additives to improve the functionality include flame retardants, lubricants and release agents such as waxes, various fatty acids, fatty acid amides, fatty acid esters, and fatty acid metal salts, various antistatic agents, slidability-improving agents such as fatty acid esters, polyolefins, olefin copolymerized elastomers, and polysiloxanes, decomposition inhibitors of the POM resin such as polyamide resins and acrylamide polymers, amide compounds, amino-substituted triazine compounds and derivatives thereof, urea and derivatives thereof, hydrazine derivatives, imidazole compounds, imide compounds, and epoxy compounds, formic acid scavengers such as melamine and hydroxides and carbonates of alkali metals, impact resistance-improving agents such as polyurethane elastomers, polyester elastomers, and polystyrene elastomers, and flame retardants such as organophosphorus compounds. In addition, the examples also include, as various additives for improving long-term stability, UV absorbers such as benzotriazole-based compounds, benzophenone-based compounds, and phenyl salicylate compounds, hindered amine-based light stabilizers, and hindered phenol-based antioxidants.

Of these, fatty acid esters are preferably used as additives. Fatty acid esters may be suitably used because of being effective in improving slidability and alleviating a kneading torque on production of the resin composition. A preferable specific example of the fatty acid ester is an ester of a monovalent fatty acid and a monovalent aliphatic alcohol. Examples of a monovalent fatty acid that is naturally derived and easily available include myristic acid, stearic acid, montanic acid, oleic acid, linoleic acid, and linolenic acid, and esters obtained from any of these monovalent fatty acids and an aliphatic alcohol can be suitably used. In particular, cetyl myristate and stearyl stearate each are more preferred in terms of the balance among characteristics such as slidability, a thermal deformation temperature, and a torque reduction amount on kneading when used as an additive. The amount of the fatty acid ester added is preferably 10% by mass or less in the resin composition also for the purpose of securing the balance among these characteristics.

In addition, an inorganic component such as a metal oxide, a metal hydroxide, a carbonate, a sulfate, a silicate compound, a glass-based filler, a silicic acid compound, metal powder or metal fiber, carbon fiber, or a carbon nanotube may be included for the purpose of improving a function such as a low thermal expansion rate or rigidity, to such an extent that the conductive performance of the resin composition of the present embodiment is not impaired.

Examples of the metal oxide include alumina, zinc oxide, titanium oxide, cerium oxide, calcium oxide, magnesium oxide, iron oxide, tin oxide, and antimony oxide. Examples of the metal hydroxide include calcium hydroxide, magnesium hydroxide, and aluminum hydroxide. Examples of the carbonate include basic magnesium carbonate, calcium carbonate, magnesium carbonate, zinc carbonate, barium carbonate, dawsonite, and hydrotalcite. Examples of the sulfate include calcium sulfate, barium sulfate, magnesium sulfate, and a gypsum fiber. Examples of the silicate compound include calcium silicate (e.g., wollastonite or xonotlite), talc, clay, mica, montmorillonite, bentonite, activated earth, sepiolite, imogolite, sericite, kaolin, vermiculite, and smectite. Examples of the glass-based filler include glass fiber, milled glass fiber, glass beads, glass flakes, and glass balloons. Examples of the silicic acid compound include silica (e.g., white carbon) and silica sand. Examples of a main element for forming the metal powder or the metal fiber include iron, aluminum, titanium, and copper, and a composite of any of such elements and another element may also be used.

The surfaces of these inorganic fillers may be treated with, for example, various surface treatment agents, such as a silane coupling agent, a titan coupling agent, an organic fatty acid, an alcohol, and an amine, a wax, and a silicone resin.

One of more of the above additives may be used in combination.

### With Regard to Constituent Components

The constituent components of the resin composition of the present embodiment can be known by combining a known separation technique and a known analysis technique. Although a method and a procedure therefor are not particularly limited, by way of example, a solution is obtained by extracting organic components form a resin composition, its components are separated by any of various chromatograph methods or the like, and then a component analysis is allowed to proceed.

To extract the organic components from the resin composition, the resin composition may be dissolved in a solvent in which the organic components are soluble. A time period required for the extraction can be shortened by finely crushing the resin composition in advance or by stirring the solvent under heating. Although the solvent to be used may be arbitrarily selected according to the properties of the organic components for forming the resin composition, in the case of a resin composition including a POM resin as in the present embodiment, a solvent such as hexafluoropropanol is suitably used.

The content of the inorganic component included in the resin composition can be known by drying and weighing the residue remaining after the separation of the organic components. Another method of knowing the content of the inorganic component of the resin composition is a method in which the temperature is raised to a temperature equal to or more than the decomposition temperature of the resin by thermogravimetric analyzer (TGA) or the like and then an ash content is quantified.

Separation of the components from the solution obtained by extracting the organic components from the resin composition is conducted by a method such as various chromatographs. Low-molecular weight additives can be separated by a gas chromatograph (GC) or high performance liquid phase column chromatograph (HPLC) method, and a high-molecular weight polymer can be separated by a gel permeation chromatograph (GPC) method or the like. In particular, when the solution includes a crosslinked polymer or gel having a large molecular weight, or when a micelle is formed in the solution, centrifugal separation or separation with a semipermeable membrane can be selected. The separated organic components can be analyzed by a known analysis approach, such as nuclear magnetic resonance (NMR) spectrum measurement, infrared absorption (IR) spectrum measurement, Raman spectrum measurement, mass spectrum measurement, or elemental analysis.

An oxazoline group-containing polymer compound chemically bonded to an inorganic component, particularly carbon black, graphite, and an organic functional group on the surface thereof can be collected from a residue, which can be obtained by dissolving the other organic components in a solvent in which the organic components are soluble followed by extraction and centrifuging the extract. This residue can be separated into fragments of each component by an appropriate chemical treatment, for example, a treatment with a strong acid or the like. Soluble components are separated by centrifugation followed by neutralization, the solvent is removed, and the resultant is washed. Thereafter, the structure can be identified by a known analysis approach such as a gas chromatograph (GC) or high performance liquid phase column chromatograph (HPLC) method, nuclear magnetic resonance (NMR) spectrum measurement, infrared absorption (IR) spectrum measurement, Raman spectrum measurement, mass spectrum measurement, or elemental analysis.

### Method for Producing Resin Composition and Resin Molded Article

A method of producing the resin composition of the present embodiment is not limited to a specific method, and a mixing method that has been generally adopted for a thermoplastic resin can be used. For example, the resin composition can be produced by mixing and kneading with a mixing machine, such as a tumbler, a V-type blender, a Banbury mixer, a kneading roll, a kneader, a single-screw extruder, or a multi-screw extruder having two or more screws. In particular, melting and kneading with a twin-screw extruder are excellent in productivity.

In the production of the resin composition, a plurality of raw materials among the POM resin, carbon black, oxazoline group-containing polymer compound, and other additives used as required may be preliminarily mixed or preliminarily kneaded in advance to prepare a kneaded product, or may be simultaneously mixed or kneaded. Particularly, in the production thereof with an extruder, kneading can be performed by providing an individual feeder for each component and sequentially adding the components in an extrusion process.

When the additive is preliminarily mixed with one or a plurality of the raw materials among the POM resin, carbon black, and oxazoline group-containing polymer compound, the mixture may be treated by a dry method or wet method. In the dry method, stirring can be performed using a stirrer such as a Henschel mixer or a ball mill, and in the wet method, a conductive resin is added to a solvent followed by stirring, and the solvent can be removed by drying after the mixing.

In the production of melt-kneading, the kneading temperature, kneading time, and feeding rate can be optionally set according to the type and performance of a kneading apparatus, the properties of the components blended and other additive components used as required. The kneading temperature is typically from 150° C. to 250° C., preferably from 160° C. to 230° C., and more preferably from 170° C. to 210° C. When the kneading temperature is 150° C. or more, the dispersibility becomes satisfactory, and when the kneading temperature is set to 250° C. or less, generation of formaldehyde or degradation in various physical properties due to thermal decomposition can be suppressed.

Any known molding methods may be employed for molding. The resin composition can be easily molded by a commonly used molding method such as extrusion molding, injection molding, or compression molding, and can be applied also to blow molding, vacuum molding, two-color molding, insert molding, or the like. A resin molded article obtained by molding the resin composition of the present embodiment is applied as parts for OA equipment and other electrical and electronic equipment, or conductive functional parts for electrical and electronic equipment. The resin molded article of the present embodiment can also be applied to structural members for an automobile, an aircraft, and the like, building members, food containers, and the like. That is, the resin composition can be applied to various production methods each including molding the resin composition with a mold to produce a resin molded article, and can be suitably used in mechanism sites of a copier housing and a container for toner cartridge, at which particularly high conductivity and slidability are required. Specifically, the resin molded article is suitably used in, for example, electrical contact parts (electrical contact components) in electrical and electronic equipment, and a photosensitive drum flange, a process cartridge part, and a bearing member in an image forming apparatus.

According to the present embodiment, a resin composition having a high conductivity, being less likely to be thermally decomposed, further having a high mechanical strength such as impact resistance and a temperature of deflection under load, and having no practical problem for injection molding applications, and a resin molded article can be obtained.

### EXAMPLES

Materials used in Examples (including Comparative Examples) are as described below.
(A) POM resin
   “DURACON® M270CA (product name)” manufactured by Polyplastics Co., Ltd.
(B) Polyethylene
   B-1: “UBE polyethylene L719 (product name)” manufactured by Ube-Maruzen Polyethylene (low density polyethylene, tensile yield stress: 13 MPa)
   B-2: “Suntec LD L1850A (product name)” manufactured by Asahi Kasei Corporation (low density polyethylene, tensile yield stress: 12 MPa)
(C) Carbon black
   C-1: “LIONITE EC300J (product name)” manufactured by Lion Specialty Chemicals Co., Ltd. (DBP oil absorption: 365 ml/100 g)
   C-2: “PRINTEX XE2-B (product name)” manufactured by Orion Engineered Carbons S.A. (DBP oil absorption: 420 ml/100 g)
(D) Oxazoline group-containing polymer compound
   “EPOCROS RPS-1005S (product name)” manufactured by NIPPON SHOKUBAI CO., LTD. (oxazoline-modified polystyrene, oxazoline equivalent: 0.27 mmol/g)
(E) Tertiary aromatic phosphine
   E-1: “HOKKO TPP®” manufactured by Hokko Chemical Industry Co., Ltd. (main component: triphenylphosphine)
   E-2: Tri-p-tolylphosphine manufactured by Tokyo Chemical Industry Co., Ltd.
(F) Other additives
   F-1: “F#3 (product name)” manufactured by Nippon Graphite Industries Co., Ltd. (flaky graphite, average particle diameter: 60 µm)
   F-2: “SPERMACETI (product name)” manufactured by NOF Corporation (main component: cetyl myristate)
   F-3: “EOCN-104S (product name)” manufactured by NIPPON KAYAKU Co., Ltd. (cresol novolac-type epoxy resin)
   F-4: Dicyandiamide manufactured by Kishida Chemical Co., Ltd. (epoxy curing agent)

### Production of Resin Compositions

The POM resin (A) was dried at a temperature of 90° C. for 3 hours in advance. Thereafter, the polyethylene (B), carbon black (C), oxazoline group-containing polymer compound (D), tertiary aromatic phosphine (E), and other additives (F) were added so that the % by mass of each component in a resin composition became a blending amount shown in Table 1. Thus, a raw material blend was produced. The blend was plasticized under conditions of a cylinder temperature of 240° C. and kneaded under conditions of 200° C. with a twin-screw extruder “TEX44α (product name)” manufactured by The Japan Steel Works, Ltd. to produce a strand. The strand was cut with a pelletizer to obtain pellets of the resin composition. The pellets obtained were subjected to the following evaluations. The results are shown in Table 2.

### Evaluation of Tertiary Aromatic Phosphine Content and Tertiary Aromatic Phosphine Oxide Content

Multi-Shot Pyrolyzer “PY-3030D (product name)” manufactured by Frontier Laboratories Ltd. as a heating furnace was connected to JMS-T200GC AccuTOF® GCx-plus (product name) manufactured by JEOL Ltd. as a gas chromatograph, and components contained were quantified by heating the resin composition.

For quantifying the tertiary aromatic phosphine oxide, which is generated by oxidation of tertiary aromatic phosphine, a solution of 50 ppm tertiary aromatic phosphine oxide manufactured by Kishida Chemical Co., Ltd. in acetone was prepared, and a calibration curve was formed in the range of 50 to 350 ng of the tertiary aromatic phosphine oxide mass. Then, the intensity ratio detected by the gas chromatograph was converted to the content.

Thermal desorption was conducted by raising the temperature from 340° C. at a rate of 20° C./min and holding the composition for 1 minute after 360° C. was reached. Thermal decomposition was conducted by holding the composition at 600° C. for 2 minutes. The measurement was conducted, using “SLB-5ms” manufactured by Sigma-Aldrich Co. LLC as a column in the gas chromatograph, by raising the column temperature from 40° C. at a rate of 20° C./min and holding the temperature at 340° C. for 5 minutes.

### Volume Resistivity Evaluation

The resin composition was portioned out under the state of the strand before cutting, and its diameter was measured with calipers. The resistance value of a range having a length of 5 cm was measured with HANDY MILLI-OHM TESTER SK-3800 (product name) manufactured by Kaise Corporation, and the volume resistivity of the resin composition was calculated.

### Thermal Stability Evaluation

When the POM resin (A) included in the resin composition has decomposed to generate a formaldehyde gas, the mass loss of the resin composition is observed. The composition was held in a stream of nitrogen at 225° C. for 2 hours using a thermogravimetric analysis (TGA) manufactured by Mettler-Toledo, and its mass loss ratio was measured.

### Charpy Impact Test and Temperature of Deflection Under Load Evaluation

The pellets of the resin composition obtained was injection-molded with an injection molding machine “SE-180D (product name)” manufactured by Sumitomo Heavy Industries, Ltd. at a cylinder temperature of 200° C. and a mold temperature of 60° C. to produce a bar test specimen type B1 (80 mm long × 10 mm wide × 4 mm thick) specified in JIS K 7152-1. The following test was conducted on a test specimen stored at normal temperature for a week after the molding and not subjected to thermal annealing.

The Charpy impact test was conducted as follows according to Determination of Charpy impact properties described in JIS K7111-1. The above test piece was machined with a shape A notch (tip radius: 0.25 mm, cutting depth: 2 mm) perpendicular to the thickness direction of the test piece, with a notching machine manufactured by YASUDA SEIKI SEISAKUSHO, LTD. The value when an edgewise impact test, in which an impact of 1 J is given from the back side of the notch, was conducted was measured using a Charpy impact tester manufactured by YASUDA SEIKI SEISAKUSHO, LTD. The measurement was conducted 5 times on different test pieces, and the average value was taken as the value of the Charpy impact resistance.

The temperature of deflection under load was determined as follows according to Determination of temperature of deflection under load described in JIS K7191-1 and 2. The temperature was raised from 30° C. at a rate of 120° C./h in a flatwise test, in which a load of 1.80 MPa is applied in the thickness direction of the test piece, and the temperature was measured at which a specified amount of deflection of 0.34 mm was reached, using HDT test apparatus 3M-2 (product name) manufactured by Toyo Seiki Seisaku-sho, Ltd. The measurement was conducted simultaneously on 3 different test pieces, and the average value was taken as the temperature of deflection under load.

TABLE 1

| Ratio of raw material charged | | Example 1 | Example 2 | Example 3 | Example 4 | Example 5 | Example 6 | Comparative Example 1 | Comparative Example 2 | Comparative Example 3 | Comparative Example 4 |
|---|---|---|---|---|---|---|---|---|---|---|---|
| POM resin | A | 74.49 | 74.39 | 74.29 | 77.29 | 76.69 | 76.69 | 74.54 | 73.94 | 76.60 | 76.35 |
| Polyethylene | B-1 | 7.50 | 7.50 | 7.50 | 7.60 | | | 7.50 | 7.50 | | |
| | B-2 | | | | | 7.50 | 7.50 | | | 7.50 | 7.50 |
| Carbon black | C-1 | 9.00 | 9.00 | 9.00 | 7.00 | | | 9.00 | 9.00 | | |
| | C-2 | | | | | 7.50 | 7.50 | | | 7.50 | 7.50 |
| Oxazoline group-containing compound | D | 1.71 | 1.71 | 1.71 | 1.52 | 1.52 | 1.52 | 1.71 | 1.71 | | |
| Tertiary aromatic phosphine | E-1 | 0.20 | 0.30 | 0.40 | 0.49 | 0.49 | | 0.15 | 0.75 | 0.50 | 0.75 |
| | E-2 | | | | | | 0.49 | | | | |
| Other additives | F-1 | 4.50 | 4.50 | 4.50 | 3.50 | 4.00 | 4.00 | 4.50 | 4.50 | 4.00 | 4.00 |
| | F2 | 2.60 | 2.60 | 2.60 | 2.60 | 2.30 | 2.30 | 2.60 | 2.60 | 2.30 | 2.30 |
| | F-3 | | | | | | | | | 1.52 | 1.52 |
| | F-4 | | | | | | | | | 0.08 | 0.08 |

TABLE 2

| Composition characteristics after kneading | Example 1 | Example 2 | Example 3 | Example 4 | Example 5 | Example 6 | Comparative Example 1 | Comparative Example 2 | Comparative Example 3 | Comparative Example 4 |
|---|---|---|---|---|---|---|---|---|---|---|
| Content of tertiary aromatic phosphine in composition (%) (1) | 0.04 | 0.08 | 0.11 | 0.14 | 0.14 | 0.14 | 0.02 | 0.21 | 0.06 | 0.16 |
| Content of tertiary aromatic phosphine oxide in composition (%) (2) | 0.16 | 0.22 | 0.29 | 0.35 | 0.35 | 0.35 | 0.13 | 0.54 | 0.44 | 0.59 |
| (1) + (2) (% by weight) | 0.20 | 0.30 | 0.40 | 0.49 | 0.49 | 0.49 | 0.15 | 0.75 | 0.50 | 0.75 |
| Volume resistivity [Ω·cm] | 4.1 | 4.0 | 3.9 | 4.8 | 6.2 | 6.3 | 4.5 | 4.0 | 6.6 | 6.4 |
| Thermal stability: weight loss ratio on heating [%] | 2.9 | 2.7 | 2.6 | 2.6 | 2.6 | 2.6 | 3.5 | 2.6 | 2.9 | 2.6 |
| Charpy impact resistance value [kJ/m^2] | 0.551 | 0.555 | 0.555 | 0.553 | 0.550 | 0.556 | 0.540 | 0.535 | 0.507 | 0.502 |
| Temperature of deflection under load [°C] | 71 | 72 | 72 | 71 | 71 | 71 | 69 | 66 | 68 | 67 |

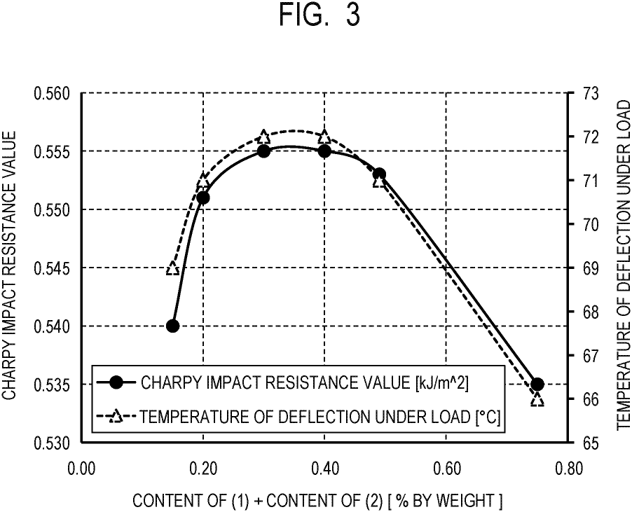

Table 1 shows the ratio of raw material charged of the materials, and Table 2 summarizes the characteristics of the compositions after kneading. FIG. 3 are the Charpy impact resistance values and the temperatures of deflection under load plotted against the sum of the content of tertiary aromatic phosphine (1) and the content of tertiary aromatic phosphine oxide (2) of Examples 1 to 4 and Comparative Examples 1 and 2.

As clearly seen from FIG. 3, in the case where the oxazoline group-containing polymer compound is added, setting the sum of the contents of the tertiary aromatic phosphine and the tertiary aromatic phosphine oxide to 0.2% by mass or more and less than 0.5% by mass has resulted in resin compositions having high impact resistance and having a high temperature of deflection under load and molded articles thereof. Additionally, in comparison with the case where an epoxy compound is used instead of the oxazoline group-containing polymer compound as in Comparative Examples 3 and 4, the ratio of oxidation of the tertiary aromatic phosphine added as a raw material has been suppressed, and consequently the amount of tertiary aromatic phosphine added can be reduced. Thus, it can be seen that resin compositions excellent particularly in impact resistance have been obtained.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-034504, filed Mar. 7, 2022, which is hereby incorporated by reference herein in its entirety.

What is claimed is:

1. A resin composition comprising:
a polyacetal resin;
polyethylene;
carbon black;
a reaction product of an oxazoline group-containing polymer represented by formula (1); and
a tertiary aromatic phosphine represented by formula (3) and/or a tertiary aromatic phosphine oxide represented by formula (4),
wherein a content of the polyacetal resin is 50% by mass or more, and
a sum of a content of the tertiary aromatic phosphine and a content of the tertiary aromatic phosphine oxide is 0.2% by mass or more and less than 0.5% by mass: 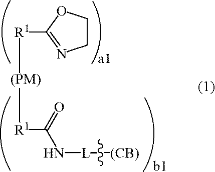
wherein PM represents a polymer comprising at least any of a styrene unit, an acryl unit, or an acrylonitrile unit,
L represents a divalent linking group having 10 or less carbon atoms and including at least one group selected from the group consisting of an alkylene group, —CO—, —O—, —NH—, and —S—, 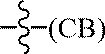
represents a bond to the carbon black,
each R¹ independently represents a single bond or a divalent hydrocarbon group having 5 or less carbon atoms optionally having a substituent, and
a1 is an integer of 0 or 1 or more, and b1 is an integer of 1 or more, 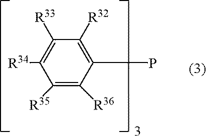
wherein R³² to R³⁶ each independently represent a hydrogen atom or an alkyl group having 2 or less carbon atoms, and 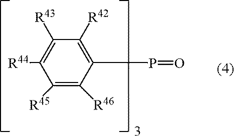
wherein R⁴² to R⁴⁶ each independently represent a hydrogen atom or an alkyl group having 2 or less carbon atoms.

2. The resin composition according to claim 1, wherein a1 and b1 in formula (1) satisfy the following:
$$100 \leq \text{a1} \text{+} \text{b1} \leq \text{200,000,} \text{and}$$
$$0.1 \leq \text{b1} / \text{a1} \text{.}$$
.

3. The resin composition according to claim 1, wherein the polymer represented by PM in formula (1) is a polymer comprising a styrene unit.

4. The resin composition according to claim 1, wherein the content of the tertiary aromatic phosphine is less than 0.3% by mass.

5. The resin composition according to claim 1, wherein a content of the polyethylene is 5% by mass or more and 15% by mass or less.

6. The resin composition according to claim 1, wherein a content of the carbon black is 7% by mass or more and 13% by mass or less.

7. The resin composition according to claim 1, wherein the content of the tertiary aromatic phosphine oxide is less than 0.4% by mass.

8. The resin composition according to claim 1, wherein the carbon black has a dibutyl phthalate oil absorption of 250 ml/100 g or more.

9. The resin composition according to claim 1, further comprising a fatty acid ester.

10. The resin composition according to claim 1, wherein the fatty acid ester is at least one of cetyl myristate or stearyl stearate.

11. The resin composition according to claim 9, wherein a content of the fatty acid ester is 10% by mass or less.

12. The resin composition according to claim 1, further comprising graphite.

13. The resin composition according to claim 12, wherein a content of the graphite is 2% by mass or more and 8% by mass or less.

14. A resin molded article comprising a resin composition comprising:
a polyacetal resin;
polyethylene;
carbon black;
a reaction product of an oxazoline group-containing polymer represented by formula (1); and
a tertiary aromatic phosphine represented by formula (3) and/or a tertiary aromatic phosphine oxide represented by formula (4),
wherein a content of the polyacetal resin is 50% by mass or more, and
a sum of a content of the tertiary aromatic phosphine and a content of the tertiary aromatic phosphine oxide is 0.2% by mass or more and less than 0.5% by mass: 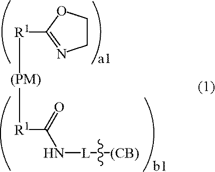
wherein PM represents a polymer comprising at least any of a styrene unit, an acryl unit, or an acrylonitrile unit,
L represents a divalent linking group having 10 or less carbon atoms and including at least one group selected from the group consisting of an alkylene group, —CO—, —O—, —NH—, and —S—, 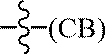
represents a bond to the carbon black,
each R¹ independently represents a single bond or a divalent hydrocarbon group having 5 or less carbon atoms optionally having a substituent, and
a1 is an integer of 0 or 1 or more, and b1 is an integer of 1 or more, 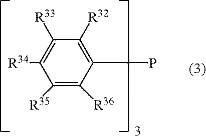
wherein R³² to R³⁶ each independently represent a hydrogen atom or an alkyl group having 2 or less carbon atoms, and 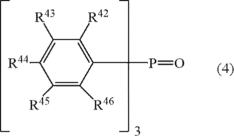
wherein R⁴² to R⁴⁶ each independently represent a hydrogen atom or an alkyl group having 2 or less carbon atoms.

15. An electrical contact part comprising the resin molded article according to claim 14.

16. A bearing member comprising the resin molded article according to claim 14.

17. Electrical and electronic equipment comprising the resin molded article according to claim 14.

18. An image forming apparatus comprising the resin molded article according to claim 14.

19. A method for producing a resin molded article, comprising kneading and heating a raw material, followed by molding,
the raw material comprising:
a polyacetal resin;
polyethylene;
carbon black;
an oxazoline group-containing polymer compound represented by formula (2); and
a tertiary aromatic phosphine represented by formula (3) and/or a tertiary aromatic phosphine oxide represented by formula (4),
wherein a content of the polyacetal resin is 50% by mass or more, and
a sum of a content of the tertiary aromatic phosphine and a content of the tertiary aromatic phosphine oxide is 0.2% by mass or more and less than 0.5% by mass, in the raw material: 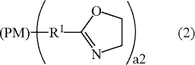
wherein PM represents a polymer including at least any of a styrene unit, an acryl unit, or an acrylonitrile unit, R¹ represents a single bond or a divalent hydrocarbon group having 5 or less carbon atoms optionally having a substituent, and a2 is an integer of 1 or more, 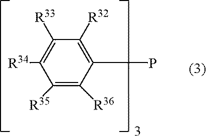
wherein R³² to R³⁶ each independently represent a hydrogen atom or an alkyl group having 2 or less carbon atoms, and 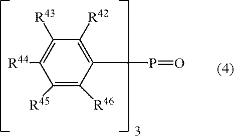
wherein R⁴² to R⁴⁶ each independently represent a hydrogen atom or an alkyl group having 2 or less carbon atoms.

20. The method for producing a resin molded article according to claim 19, wherein a2 in formula (2) satisfies the following:
$$100 \leq \text{a2} \leq \text{200,000} \text{.}$$
.
